(19) United States
(12) Patent Application Publication
(10) Pub. No.: US 2012/0032119 A1
(43) Pub. Date: Feb. 9, 2012

(54) METHOD FOR PRODUCING LITHIUM IRON PHOSPHATE

(75) Inventors: Tomoyuki Tahara, Tokyo (JP); Minoru Sakai, Tokyo (JP)

(73) Assignee: JFE CHEMICAL CORPORATION, Tokyo (JP)

(21) Appl. No.: 13/203,326

(22) PCT Filed: Mar. 10, 2010
(86) PCT No.: PCT/JP2010/001691

§ 371 Date: Sep. 8, 2011

(30) Foreign Application Priority Data
Mar. 13, 2009 (JP) 2009-061867
Jul. 21, 2009 (JP) 2009-170321
Nov. 30, 2009 (JP) 2009-272731

(51) Int. Cl. H01B 1/04; H01M 4/58; C01B 25/45

(52) U.S. Cl. 252/506; 423/306

(57) ABSTRACT

A method for producing lithium iron phosphate includes: an aqueous solution preparing step of preparing an aqueous solution containing a phosphoric acid and a carboxylic acid; a first forming step of adding iron particles containing 0.5 mass % or more of oxygen to the aqueous solution, and making the phosphoric acid and the carboxylic acid and the iron particles react with each other in the aqueous solution under an oxidizing atmosphere, to form a first reaction liquid is formed by; the second forming step of adding a lithium source to the first reaction liquid obtained in the synthesizing step to form a second reaction liquid; the precursor forming step of drying the second reaction liquid to form a lithium iron phosphate precursor; and the primary baking step of baking the lithium iron phosphate precursor under a non-oxidizing atmosphere thus obtaining lithium iron phosphate.

### RELATED APPLICATIONS

This is a §371 of International Application No. PCT/JP2010/001691, with an international filing date of Mar. 10, 2010 (WO 2010/103821 A1, published Sep. 16, 2010), which is based on Japanese Patent Application No. 2009-061867 filed Mar. 13, 2009, Japanese Patent Application No. 2009-170321 filed Jul. 21, 2009 and Japanese Patent Application No. 2009-272731 filed Nov. 30, 2009.

### FIELD

This disclosure relates to a method for producing a cathode active material for a secondary battery represented by a lithium-ion battery, and more particularly to a method for producing lithium iron phosphate.

### BACKGROUND

With respect to miniaturized lithium-ion batteries which have become widespread mainly in the field of mobile apparatuses, enhancement of the performance has been realized through improvement of anode active material or development of an electrolytic solution or the like. On the other hand, with respect to a cathode active material, no remarkable technical innovation has been made up to now from the time that the commercialization of miniaturized lithium-ion batteries started, and lithium cobaltate (LiCoO₂) which contains expensive rare metal has been mainly used. Besides being expensive, lithium cobaltate is not sufficient in thermal and chemical stability and emits oxygen under a high temperature of approximately 180° C. thus giving rise to a possibility of igniting an organic electrolyte whereby safety still remains a drawback.

Accordingly, in the development of the use of lithium-ion batteries which envisages the future use of a lithium-ion battery in a large-sized apparatus, the development of a cathode active material which is cheaper than conventionally used lithium cobaltate and is thermally and chemically stable for securing high safety is indispensable.

Currently, a material which is considered promising as a new cathode active material capable of replacing lithium cobaltate is olivine lithium iron phosphate (LiFePO₄, simply referred to as “lithium iron phosphate” hereinafter) which is an iron-based active material and exhibits high safety in addition to less restriction in terms of resource problems and less toxicity. Lithium iron phosphate is a highly safe active material since lithium iron phosphate does not emit oxygen up to approximately 400° C. because of strong P-O bonding in the crystalline structure, and is also an active material which exhibits excellent long-period stability and rapid charge characteristics.

In using lithium iron phosphate as a cathode active material, to allow lithium iron phosphate to secure a high-speed charge/discharge characteristic which is a characteristic that the cathode active material is requested to satisfy, it is necessary to improve the electron conduction of lithium iron phosphate and shorten a diffusion distance of lithium ions.

As a measure to cope with such problems, it is considered effective to cover surfaces of lithium iron phosphate particles with a conductive material and form lithium iron phosphate particles into fine particles having a size of approximately 100 nm or less, thus increasing the reaction surface area. Further, it has been also reported that doping other elements on lithium iron phosphate is effective in improving electron conduction and stabilization of the crystalline structure.

Accordingly, as described above, development of a method for producing fine lithium iron phosphate particles whose surfaces are covered with an electric conductive material stably at a low cost becomes important to realize the practical use of lithium iron phosphate as a cathode active material.

As a method for producing lithium iron phosphate aimed at lowering the cost, a method which uses inexpensive iron particles as an iron source has been known.

For example, in WO 2004/036671, there is disclosed a method where metallic iron and a compound liberating a phosphoric acid ion are reacted first with each other in an aqueous solution and, thereafter, lithium carbonate or lithium hydroxide is added to the aqueous solution to prepare a precursor of lithium iron phosphate and the precursor is dried, the dried material is subject to primary baking at a temperature within a temperature range from 300 to 450° C., and a substance from which conductive carbon is formed by thermo decomposition is added to the baking material, and the mixture is baked at a temperature of 500 to 800° C.

However, in the above-mentioned method described in WO 2004/036671, since the metallic iron of high purity of 99.9% or more reacts with a phosphoric acid in preparing the precursor, aggregate particles of iron phosphate (Fe₃(PO₄)₂.8H₂O) which is a sparingly soluble bivalent iron compound are formed and grown and the solution becomes a creamy high-viscosity material which exhibits color ranging from white to light blue. As a result, agitation of solution becomes insufficient, thus giving rise to drawbacks including unreacted metallic iron is liable to remain and raw materials are not uniformly mixed with each other. Further, also in the method disclosed in WO 2004/036671, an acid such as a hydrochloric acid or an oxalic acid is added to promote a reaction of unreacted metallic iron. However, when a hydrochloric acid is added, a product is liable to be oxidized, while when an oxalic acid is added, it is difficult to uniformly prepare a precursor due to the formation of stable iron oxalate as a deposit in the form of a single body or the like. Further, it is difficult to uniformly mix carbon black or the like which is added as conductive carbon to a precursor at an atomic level. Hence, the effect of carbon black or the like as a reducing agent is small in a temperature range of primary baking where the precursor is liable to be oxidized.

JP-A-2006-131485 discloses a method in which iron powder, a lithium salt and a phosphate compound are dissolved in an organic acid aqueous solution to prepare a precursor and, then, the precursor is dried by spraying and, thereafter, the dried material is baked at a temperature of 500° C. or more.

However, the above-mentioned method described in JP-A-2006-131485 has a drawback that although an effective bivalent iron can be formed by oxidizing iron with an organic acid or a mixed organic acid, it is difficult to make bivalent iron present in a stable state. Further, when lithium salt is lithium nitrate, nitrate ion acts as an oxidant at the time of baking. Further, although it may be possible to use lithium acetate as lithium salt, lithium acetate is an expensive raw material. Hence, use of lithium acetate is not effective in lowering cost. Further, although organic compounds which generate pyrolytic carbon are mixed in a precursor solution in the above-mentioned method, some organic compounds are carbonized alone at the time of baking so that surfaces of lithium iron phosphate particles cannot be effectively covered with pyrolytic carbon.

JP-A-2007-305585 describes a method where iron powder is first reacted in an aqueous solution containing a phosphoric acid and a citric acid, lithium hydroxide is added to the aqueous solution and, then, a precursor is prepared by adding metal oxide or a metal salt which is changed to conductive oxide by baking to the aqueous solution, the precursor is dried and, finally, a dried product of the precursor is baked.

However, in the above-mentioned method, the citric acid does not effectively act as a chelating agent when iron powder reacts with the phosphoric acid so that iron in the precursor is oxidized to trivalence to form ferric phosphate which is a trivalent iron compound. Further, the method describes an example where vanadium oxide V₂O₅ is added as a conductive oxide. However, in this method, vanadium oxide is added after the formation of the precursor of lithium iron phosphate. Hence, vanadium is not doped and is adhered to peripheries of the lithium iron phosphate particles.

JP-A-2008-4317 describes a method for producing lithium iron phosphate for batteries where the lithium iron phosphate is formed by baking a mixture which contains iron powder having an average particle size of 20 to 150 μm and apparent density of 2 g/cm³ or less, a phosphate compound and a lithium compound.

However, the method described in JP-A-2008-4317 also, in the same manner as the method described in JP-A-2006-131485, has the drawback that it is difficult to make bivalent iron present in a stable state.

As set forth above, when iron particles are used as an iron source in a method for synthesizing lithium iron phosphate, the prior art cannot sufficiently control the reaction of iron particles. Accordingly, due to a reason that unreacted iron particles remain, a reason that the oxidation of iron excessively progresses so that a crystalline trivalent iron compound is formed or the like, a precursor of lithium iron phosphate cannot be uniformly mixed and prepared at an atomic level whereby lithium iron phosphate which is obtained as a final product cannot secure a sufficient discharge capacity. Further, in improving various characteristics of lithium iron phosphate by doping other elements on the lithium iron phosphate, the prior art cannot dope other elements on the lithium iron phosphate uniformly.

It could therefore be helpful to provide a method for producing a cathode active material made of inexpensive lithium iron phosphate possessing a high discharge capacity by preparing a precursor of lithium iron phosphate where components are uniformly mixed at an atomic level by controlling a reaction of iron particles.

### SUMMARY

We provide method for producing lithium iron phosphate including preparing an aqueous solution containing a phosphoric acid and a carboxylic acid; adding iron particles containing 0.5 mass % or more of oxygen to the aqueous solution, and causing the phosphoric acid, and the carboxylic acid, the iron particles to react with each other in the aqueous solution under an oxidizing atmosphere, and thereby form a first reaction liquid; adding a lithium source to the first reaction liquid to form a second reaction liquid; drying the second reaction liquid to form a lithium iron phosphate precursor; and baking the lithium iron phosphate precursor under a non-oxidizing atmosphere to obtain lithium iron phosphate.

### DETAILED DESCRIPTION

We discovered that, in producing lithium iron phosphate having a high discharge capacity as a cathode active material using an inexpensive iron particle raw material, it is effective to determine the amount of oxygen chemically bonded to iron particles, to allow a carboxylic acid to coexist when the iron particles and the phosphoric acid are reacted with each other, and to cause the reaction in an oxidizing atmosphere. We also discovered that a chelate substance of iron phosphate which uniformly disperses in an aqueous solution is obtained by the above-mentioned reaction, and by adding a lithium source to the aqueous solution subsequently, a precursor of lithium iron phosphate in which raw materials are uniformly mixed at an atomic level is obtained. Further, we discovered that, in improving various characteristics of lithium iron phosphate by doping other elements on the lithium iron phosphate, by adding elements which can be doped on an aqueous solution which contains a phosphoric acid and a carboxylic acid, lithium iron phosphate which is uniformly doped with the elements can be obtained.

A method for producing lithium iron phosphate thus includes: an aqueous solution preparing step of preparing an aqueous solution; a first forming step of forming a first reaction liquid; a second forming step of forming a second reaction liquid; a precursor forming step; and a primary baking step.

The aqueous solution preparing step comprises preparing an aqueous solution containing a phosphoric acid and a carboxylic acid.

The first forming step comprises adding iron particles containing 0.5 mass % or more of oxygen to the aqueous solution, and making the phosphoric acid and the carboxylic acid and the iron particles react with each other in the aqueous solution under an oxidizing atmosphere, to form a first reaction liquid.

The second forming step comprises adding a lithium source to the first reaction liquid obtained in the first forming step, to form a second reaction liquid.

The precursor forming step comprises drying the second reaction liquid to form the lithium iron phosphate precursor.

The primary baking step comprises baking the lithium iron phosphate precursor under a non-oxidizing atmosphere to obtain lithium iron phosphate.

A phosphoric acid used in the aqueous solution preparation step may preferably be an orthophosphoric acid.

The carboxylic acid used in the aqueous solution preparation step may preferably be at least one selected from the group consisting of a tartaric acid, a malic acid and a citric acid. A content of carboxylic acid may preferably be 0.18 to 0.5 mol for 1 mol of iron in the iron particles. A residual carbon rate of the carboxylic acid may preferably be 3 mass % or more. The residual carbon rate of the carboxylic acid may more preferably be 3 to 20 mass %.

The iron particles may preferably be at least one selected from the group consisting of reduced iron powder, atomized iron powder and electrolytic iron powder. Further, the iron particles may preferably contain 0.6 to 2 mass % of oxygen.

It is desirable that lithium source in the second forming step is a water-soluble lithium salt.

To dope other elements on lithium iron phosphate, it is desirable to dissolve metal or a compound which is an element to be doped in an aqueous solution containing a phosphoric acid and a carboxylic acid in the aqueous solution preparation step.

It is desirable that the precursor forming step comprises drying the second reaction liquid by a spray drying method to form the lithium iron phosphate precursor.

It is preferable that the primary baking step comprises baking the lithium iron phosphate precursor under a non-oxidizing atmosphere at a temperature of 300° C. or more to obtain the lithium iron phosphate.

It is desirable that the method for producing lithium iron phosphate further comprises a secondary baking step of mixing the lithium iron phosphate obtained in the primary baking step and a carbon source, and baking the mixture under a non-oxidizing atmosphere thus obtaining lithium iron phosphate whose surface is covered with carbon. It is desirable that the carbon source is a substance which generates carbon through thermal decomposition thereof at the time of secondary baking or conductive carbon. The carbon source may preferably be added such that a carbon content contained in lithium iron phosphate after the secondary baking becomes 1 to 5 mass %.

It is desirable to use the lithium iron phosphate as a cathode active material for a secondary battery.

Accordingly, it is possible to produce lithium iron phosphate excellent in high-speed charge/discharge characteristics which are important characteristics to be satisfied by a cathode active material at a low cost and in a stable manner.

Our methods are thus explained in detail hereinafter.

The method for producing lithium iron phosphate includes:

an aqueous solution preparing step of preparing an aqueous solution containing a phosphoric acid and a carboxylic acid;

a first forming step of adding iron particles containing 0.5 mass % or more of oxygen to the aqueous solution, and making the phosphoric acid and the carboxylic acid and the iron particles react with each other in the aqueous solution under an oxidizing atmosphere, to form a first reaction liquid;

a second forming step of adding a lithium source to the first reaction liquid obtained in the first forming step, to form a second reaction liquid;

a precursor forming step of drying the second reaction liquid to form a lithium iron phosphate precursor; and

a primary baking step of baking the lithium iron phosphate precursor under a non-oxidizing atmosphere thus obtaining lithium iron phosphate.

As iron particles, it is possible to use reduced iron powder which is produced by reducing mill scales (ferric oxide) using coke, atomized iron powder which is produced by pulverizing and cooling molten steel using highly-pressurized water, electrolytic iron powder which is produced by precipitating on an anode by applying electrolysis to aqueous ferric salt solution or the like. An average particle size of iron powder may preferably be 100 μm or less. Although an average particle size of ordinary general-industry-use iron powder is 70 to 80 μm, ordinary general-industry-use iron powder contains particles having a maximum particle size of 150 to 180 μm. Accordingly, the use of iron powder after increasing the reaction surface by removing coarse particles using a sieve or turning coarse particles into fine particles by mechanical milling or the like when necessary is advantageous in synthesizing chelate substances of iron phosphate while promoting a subsequent reaction of iron powder with phosphate and a carboxylic acid.

Oxygen contained in iron powder indicates oxygen which is chemically bonded to iron. It is a prerequisite that oxygen content is 0.5 mass % or more to synthesize chelate substances of iron phosphate. The oxygen content may preferably be 0.6 mass % or more. When the oxygen content of iron particles is less than 0.5 mass %, priority is assigned to a direct reaction between metallic iron and a phosphoric acid so that aggregate particles of iron phosphate (Fe₃(PO₄)₂.8H₂O) which is an sparingly soluble bivalent iron compound are formed and grown whereby the solution becomes a creamy high-viscosity material which exhibits color ranging from white to light blue. As a result, agitation of solution becomes insufficient thus giving rise to drawbacks including unreacted metallic iron is liable to remain and raw materials are not uniformly mixed with each other. When the oxygen content of iron particles is 2 mass % or less, there is no segregation of scales of ferric oxide on surfaces of iron powder whereby a reaction between iron powder and an aqueous solution of phosphoric acid and a carboxylic acid is not impeded. Accordingly, the oxygen content of iron particles may preferably be 2 mass % or less. Determination of oxygen content in the iron particles is performed in accordance with a vacuum melting infrared absorbing method stipulated in JIS Z 2613 (1992) using TC436 made by LECO Corporation.

To set an oxygen content of iron particles to 0.5 mass % or more, in a case where reduced iron powder is used as a raw material, for example, a temperature at which mill scales (ferric oxide) are reduced using coke may be set to a temperature of approximately 800 to 1000° C. lower than a usual temperature of 1000 to 1200° C.

Further, to use water atomized iron powder as a raw material, molten steel is pulverized and cooled using highly pressurized water and, thereafter, pulverized steel may be positively brought into contact with air in a drying step.

To elevate purity of the iron particles, usually, raw-material iron powder is subject to hydrogen reduction thus producing iron particles having an oxygen content of approximately 0.4 mm % or less. Accordingly, the iron particles may be produced by adjusting the degree of hydrogen reduction.

A phosphoric acid may preferably be an aqueous solution of an orthophosphoric acid (H₃PO₄). However, an aqueous solution of higher-order condensed phosphoric acid (Hₙ₊₂PₙO₃ₙ₊₁) may be also used as a phosphoric acid. An orthophosphoric acid which amounts to 75 to 85 mass % can be usually used as an industrial product. An addition amount of a phosphoric acid is 1 mol for 1 mol of iron in terms of a stoichiometric equivalent. However, there is no problem even when the addition amount of phosphoric acid exceeds 1 mol by approximately 0.1 mol.

A carboxylic acid indicates an organic compound having a carboxyl group, and functions as a chelating agent at the time of synthesizing chelate substances of iron phosphate. As the above-mentioned carboxylic acid, a carboxylic acid which exhibits a strong chelating force for iron, for example, tartaric acid, malic acid, citric acid and the like can be named. Among these carboxylic acids, it is particularly preferable to use citric acid which exhibits a strong chelating force and forms a hardly-oxidized chelating substance.

Further, carbon remains at the time of baking. Hence, the carboxylic acid also functions as a reducing agent. To allow the carboxylic acid to exhibit such a function, it is desirable to set the residual carbon ratio of the carboxylic acid to 3 mass % or more. When the residual carbon ratio of the carboxylic acid is less than 3 mass %, the precursor is liable to be oxidized with a trace amount of oxygen existing in the atmosphere.

Further, it is preferable to set the above-mentioned residual carbon ratio to 20 mass % or less. When the residual carbon ratio exceeds 20 mass %, residual carbon content after baking becomes excessive. With respect to the residual carbon ratio of the above-mentioned carboxylic acid, the residual carbon ratio is 7 mass % in the case of a tartaric acid, the residual carbon ratio is 12 mass % in the case of a malic acid, the residual carbon ratio is 7 mass % in the case of a citric acid hydrate, and the residual carbon ratio is less than 1 mass % in the case of oxalic acid dehydrate, acetic acid or the like.

“Residual carbon rate” is a value obtained in such a manner that residual carbon after baking is determined in accordance with a high-frequency induction heating farness combustion-infrared absorption method stipulated in JIS G 1211 (1995), and the residual carbon is divided by an initial amount of carboxylic acid.

A content of carboxylic acid may preferably be set to 0.18 to 0.5 mol for 1 mol of iron, and may preferably be set to 0.2 to 0.4 mol for 1 mol of iron. When the content of carboxylic acid is less than 0.18 mol, the above-mentioned chelating effect derived from a carboxylic acid is decreased. Hence, metallic iron and phosphoric acid ion directly react with each other and aggregate particles of sparingly soluble iron phosphate are formed and grown whereby the solution becomes a creamy high-viscosity material which exhibits color ranging from white to light blue. As a result, agitation of the aqueous solution becomes insufficient thus giving rise to drawbacks including unreacted metallic iron is liable to remain and raw materials are not uniformly mixed with each other. On the other hand, when the above-mentioned content of carboxylic acid exceeds 0.5 mol, synthesized chelate substances of iron phosphate are uniformly dispersed in the aqueous solution (raw materials being mixed uniformly). However, residual carbon content after baking becomes excessive. As a result, an apparent discharge capacity of lithium iron phosphate obtained as a final product is lowered.

As an atmosphere where a reaction is made by adding iron particles to an aqueous solution which contains a phosphoric acid and a carboxylic acid, it is necessary to provide an oxidizing atmosphere. This is because oxygen on surfaces of iron particles is consumed as the chelating reaction progresses and the chelating reaction cannot be sustained. Hence, priority is assigned to a direct reaction between metallic iron and phosphoric acid ion whereby sparing soluble aggregate particles of iron phosphate are formed and grown.

In view of such a circumstance, by bringing the above-mentioned atmosphere at the time of reaction into an oxidizing atmosphere, oxygen is supplemented by properly oxidizing surfaces of iron particles thus sustaining the chelating reaction. The oxidizing atmosphere indicates a state where surfaces of iron particles in the aqueous solution can be properly oxidized. Such a state is obtained, for example, by bringing an interface of the aqueous solution and an oxygen containing gas into contact with each other, by introducing bubbles or nano-bubbles of dissolved oxygen or oxygen containing gases in an aqueous solution or the like. Further, as a specific manipulation, agitation under an air atmosphere, bubbling of air or the like can be named.

In the above-mentioned chelating reaction, an aqueous solution temperature may preferably be controlled within a range from 10 to 40° C., and may be more preferably controlled within a range from 20 to 30° C. By controlling the aqueous solution temperature within a range from 10 to 40° C., surfaces of the iron particles which newly appear due to consumption of oxygen by the above-mentioned chelating reaction are properly oxidized as being brought into contact with dissolved oxygen, air bubbles or the like in the aqueous solution whereby chelate substances of iron phosphate can be continuously formed. When the aqueous solution temperature is less than 10° C., the chelating reaction of iron particles becomes slow. Hence, it takes a long time before the reaction is completely finished. On the other hand, when the aqueous solution temperature exceeds 40° C., oxidation for supplementing oxygen to surfaces of the iron particles where oxygen is consumed cannot catch up with the consumption of oxygen. Accordingly, priority is assigned to a direct reaction between metallic iron and phosphoric acid so that aggregate particles of sparingly soluble iron phosphate are formed and grown thus giving rise to a possibility that the solution becomes a creamy high-viscosity material which exhibits color ranging from white to light blue.

When iron particles are added to an aqueous solution which contains a phosphoric acid and a carboxylic acid, and the aqueous solution is exposed to an oxidizing atmosphere, the carboxylic acid chelates iron by way of oxygen or a hydroxy group present on surfaces of iron particles, and iron phosphate is formed due to bonding of the phosphoric acid with iron by oxidation. As a result, it is estimated that chelate substances of iron phosphate expressed by formula 1 is synthesized, and a first reaction liquid in which the chelate substances are uniformly dispersed is obtained.

By adding a lithium source to the first reaction liquid in which the chelate substances are uniformly dispersed in this manner, a precursor of lithium iron phosphate where raw materials are uniformly mixed at an atomic level is obtained.

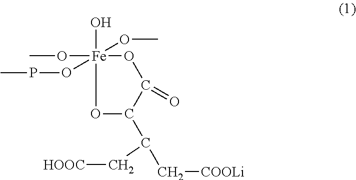

Although the type of lithium source to be added to the first reaction liquid is not limited provided that the lithium source is a water soluble lithium salt, lithium hydroxide or lithium carbonate which does not generate a harmful gas at the time of baking is particularly preferable. When the lithium source is added to the above-mentioned first reaction liquid, color of the reaction liquid is changed to dark green, and a second reaction liquid having pH of 6 to 7 is obtained. Further, when an X ray diffraction analysis is applied to a dried product obtained by drying the second reaction liquid (precursor of lithium iron phosphate), no crystalline compound is detected, and an amorphous phase derived from chelate substances which are mixed uniformly at an atomic level is confirmed.

It is estimated that when the second reaction liquid is formed by adding the lithium source to the first reaction liquid, some hydrogen in a carboxylic group of the chelate substances expressed by formula 1 are replaced with lithium so that the chelate substances of lithium iron phosphate expressed by formula 2 is formed. Although the chelate substances of lithium iron phosphate is present in the second reaction liquid in a dispersed state, there may be instances where some chelate substances are present in the form of aggregate particles and become a deposit. In such a case, to make the precursor solution uniform, it is desirable to make the aggregate particles fine by wet mechanical milling. As a wet milling method, a beads mill, a wet jet mill, an ultrasonic irradiation or the like is named.

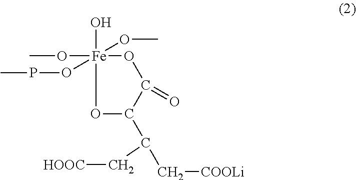

In doping other elements on lithium iron phosphate, by dissolving in advance a metal or compound which is an element to be doped into an aqueous solution which contains phosphoric acid and a carboxylic acid, the element to be doped can be uniformly mixed into the aqueous solution. For example, such metal or compound of the element to be doped include Ti(OH)₄, TiOSO₄.H₂O in the case of titanium, FeV, V₂O₅, VOSO₄.2H₂O in the case of vanadium, Mg, MgO, Mg(OH)₂ in the case of magnesium, WO₃, H₂WO₄ in the case of tungsten, and MnCO₃.nH₂O, Mn(CH₃COO)₂ in the case of manganese. In the case where a doped element dissolved in advance in an aqueous solution containing phosphoric acid and a carboxylic acid is reduced due to the addition of iron particles so that the doped element is brought into a low oxidized state, it is expected that the doped element acts as an electron donor. Although the doping amount may depend on the type of the element, in general, replacement of 0.1 mol % or more of the iron element is preferable and, particularly, replacement of 0.5 mol % or more of the iron element is more preferable. When the doping amount is less than 0.1 mol % of the iron element, the doping effect can be hardly acquired. An upper limit of the doping amount is largely changed due to factors such as ion radius, valency, coordination number of an element to be doped. Hence, the upper limit of the doping amount cannot be necessarily decided. However, when the doping amount exceeds a threshold value, there exists a tendency that characteristics are deteriorated due to the localization of electrons due to the formation of an impurity phase or a change of the band structure.

To dry the second reaction liquid, it is preferable to adopt a spray dry method which exhibits favorable dry efficiency. In the spray dry method, a specimen solution is dried by spraying the specimen solution in high-temperature heated air. Hence, powder having a uniform shape can be manufactured. In adopting the spray dry method, it is preferable to set an inlet temperature (heating air temperature) in a spray dry device to 150 to 250° C. by taking a fact that an oxidizing temperature of a precursor (of lithium iron phosphate) is approximately 250° C. into consideration. When the inlet temperature is set to 150 to 250° C., the temperature of a formed dried product becomes approximately 100 to 150° C. although the temperature depends on a balance with a liquid feeding amount. The lithium iron phosphate precursor which is the formed dried product takes a powdery form. A particle size of the precursor is preferably 100 μm or less, is more preferably 80 μm or less, and is still more preferably 50 μm or less. In the case where the particle size of the precursor exceeds 100 μm, coarse particles remain when milling performed after baking is insufficient, while when an electrode is formed using the precursor as a cathode active material, there exists a possibility that a current collector is damaged.

By baking the lithium iron phosphate precursor at a temperature of 300° C. or above under a non-oxidizing atmosphere, H₂O, CO₂, H₂ which are contained in the lithium iron phosphate precursor are eliminated through thermal decomposition, the dried product having an amorphous phase is crystallized whereby a crystalline body of lithium iron phosphate having the olivine structure is obtained. The baking temperature is preferably 300° C. or above, and is more preferably 350 to 700° C. When the baking temperature is below 300° C., elimination of H₂O, CO₂, H₂ which are volatile components through thermal decomposition becomes insufficient and, also, crystallization cannot be acquired. On the other hand, with respect to an upper limit of the baking temperature, when the upper limit exceeds 700° C., coarseness of the obtained crystal particles progresses. Accordingly, the upper limit of the baking temperature is preferably 700° C. or below. Baking is performed under a non-oxidizing atmosphere to prevent oxidization of the lithium iron phosphate precursor.

Next, using lithium iron phosphate which is the above-mentioned baked product as a primary baked product, a carbon source is mixed into the primary baked product and, then, the mixture is subjected to secondary baking. Due to such secondary baking, crystallinity of lithium iron phosphate may be enhanced and, at the same time, conductivity of lithium iron phosphate may be enhanced since the surface of lithium iron phosphate is covered with carbon or carbon is adhered to the surface of lithium iron phosphate.

As the carbon source to be mixed with lithium iron phosphate, a substance which forms carbon through thermal decomposition at the time of secondary baking or conductive carbon is used. The substance which forms carbon through thermal decomposition at the time of secondary baking may preferably be a substance which is melted at the time of secondary baking and wets the surface of lithium iron phosphate particles. For example, a saccharide such as glucose, fructose, maltose, sucrose, ascorbic acid or erythorbic acid, carboxymethylcellulose, acenaphthylene, quinoline insoluble-less pitch (quinoline insoluble ≦0.1 mass %, ash ≦0.01 mass %) or the like can be used. As conductive carbon, for example, carbon black, acetylene black, Ketjen black, VGCF, carbon nano fiber, fullerene or the like can be used. These substances can be used in a single form or in a combination of the plurality of substances.

As a method for mixing the carbon source into the primary baked product, a method where the carbon source is added to the primary baked product before or after the primary baked product is pulverized by wet or dry milling, and the mixture is pulverized using a ball mill, a jet mill or the like. An addition amount of the carbon source is preferably set such that the amount of carbon contained in lithium iron phosphate after secondary baking becomes 1 to 5 mass %, and the addition amount of the carbon source may more preferably be set such that such carbon content becomes 1.5 to 4 mass %. When the carbon content is less than 1 mass %, conductivity of lithium iron phosphate becomes insufficient, thus giving rise to a possibility that the performance of lithium iron phosphate particles which constitute a cathode active material cannot be sufficiently achieved. On the other hand, when the carbon content exceeds 5 mass %, there exists a tendency where apparent discharge capacity is lowered. When secondary baking is performed, the primary baking is preferably performed under a non-oxidizing atmosphere at a temperature of 350 to 400° C. Although lithium iron phosphate surely crystallized by being baked at a temperature of 350° C. or above, lithium oxide phosphate particles grow along with the elevation of temperature. Hence, it is sufficient to perform primary baking at a temperature of 400° C.

Secondary baking is preferably performed at a temperature of 550 to 750° C. under non-oxidizing atmosphere, and secondary baking is more preferably performed at a temperature of 600 to 700° C. When a substance which generates pyrolytic carbon is used as the carbon source, generation of pyrolytic carbon becomes insufficient at a temperature below 550° C. thus giving rise to a possibility that conductivity of lithium iron phosphate obtained after secondary baking cannot be sufficiently exhibited. On the other hand, when the secondary baking is performed at a temperature exceeding 750° C., there is a possibility that lithium iron phosphate particles become coarse.

As described above, the lithium iron phosphate precursor in which the raw materials are uniformly mixed at an atomic level is obtained such that iron particles containing 0.5 mass % or more of oxygen are added to an aqueous solution containing phosphoric acid and a carboxylic acid, chelate substances of iron phosphate are synthesized by making these elements react with each other under an oxidizing atmosphere, and a lithium source is added to the chelate substances and the mixture is dried. Then, by baking the lithium iron phosphate precursor, lithium iron phosphate having high performance can be obtained as an inexpensive cathode active material.

Although our methods are specifically explained using examples hereinafter, this disclosure is not limited to the examples.

### Example 1

10 mol of phosphoric acid of 85 mass % and 2 mol of citric acid hydrate were dissolved in 2000 g of distilled water, 10 mol of iron powder (produced by JFE Steel Corporation, oxygen content: 0.68 mass %, average particle size: 80 apparent density: 3.18 g/cm³) was added to the mixture solution, and a reaction between these materials was continued for 1 day while agitating these materials under an air atmosphere at a liquid temperature of 25 to 30° C. Then, an aqueous solution containing 10 mol of lithium hydroxide was added to the mixture solution thus preparing a precursor of lithium iron phosphate. The precursor was dried by a spray dryer (FOC16 made by OHKAWARA KAKOHKI CO., LTD.) at an inlet temperature of 200° C. thus obtaining dried powder having an average particle size of approximately 30 μm in SEM observation. Primary baking was applied to the dried powder in a nitrogen gas flow at a temperature of 400° C. for 5 hours. Then, as a carbon source, 40 g of ascorbic acid was added to the whole primary baking product, and the primary baking product was subjected to wet milling and mixing using a ball mill. Subsequently, the obtained mixture was dried and, thereafter, secondary baking was applied to the obtained mixture in a nitrogen gas flow at a temperature of 600° C. for 10 hours. Finally, the baking mixture was subjected to screening using a sieve having meshes of 75 μm thus preparing lithium iron phosphate. An oxygen content of iron powder was determined using TC436 made by LECO Corporation.

Apparent density of iron powder is measured in accordance with JIS Z 2504 (2000).

### Example 2

Lithium iron phosphate was prepared in the same manner as the Example 1 except for that 2 mol of malic acid was used in place of citric acid hydrate in the Example 1.

### Example 3

Lithium iron phosphate was prepared in the same manner as the Example 1 except for that 2 mol of tartaric acid was used in place of citric acid hydrate in the Example 1.

### Example 4

Lithium iron phosphate was prepared in the same manner as the Example 1 except for that an amount of citric acid hydrate was set to 2.5 mol, and an ascorbic acid was not added to the primary baking product in the Example 1.

### Example 5

Lithium iron phosphate was prepared in the same manner as the Example 1 except for that iron powder (produced by KISHIDA CHEMICAL Co., Ltd., oxygen content: 1.55 mass %, average particle size: 70 μm, apparent density: 2.47 g/cm³) was used in the Example 1.

### Example 6

Lithium iron phosphate was prepared in the same manner as the Example 1 except for that 0.05 mol (replacing 1 mol % of iron element) of vanadium pentoxide V₂O₅ which is a vanadium source was added to and dissolved in a mixed solution containing a phosphoric acid and a citric acid hydrate, and 9.9 mol of iron powder equal to iron powder used in the Example 1 was added to the mixed solution in the Example 1.

### Example 7

Lithium iron phosphate was prepared in the same manner as the Example 1 except for that 0.1 mol (replacing 1 mol % of iron element) of titanyl sulfate which is a titanium source was added to and dissolved in a mixed solution which is phosphoric acid and citric acid hydrate, and 9.9 mol of iron powder equal to iron powder used in the Example 1 was added to the mixed solution in the Example 1.

### Example 8

Lithium iron phosphate was prepared in the same manner as the Example 1 except for that 0.1 mol (replacing 1 mol % of iron element) of magnesium oxide which is a magnesium source was added to and dissolved in a mixed solution which is phosphoric acid and citric acid hydrate, and 9.9 mol of iron powder equal to iron powder used in the Example 1 was added to the mixed solution in the Example 1.

### Example 9

Lithium iron phosphate was prepared in the same manner as the Example 1 except for that 0.1 mol (replacing 1 mol % of iron element) of manganese acetate which is a manganese source was added to and dissolved in a mixed solution which is phosphoric acid and citric acid hydrate, and 9.9 mol of iron powder equal to iron powder used in the Example 1 was added to the mixed solution in the Example 1.

### Comparative Example 1

Lithium iron phosphate was prepared in the same manner as the Example 1 except for that iron powder (produced by JFE Steel Corporation, oxygen content: 0.41 mass %, average particle size: 80 μm, apparent density: 2.55 g/cm³) was used in the Example 1.

### Comparative Example 2

Lithium iron phosphate was prepared in the same manner as the Example 1 except for that the agitation of solution after iron powder was added was performed under a nitrogen atmosphere in the Example 1.

### Comparative Example 3

Lithium iron phosphate was prepared in the same manner as the Example 1 except for that 2 mol of oxalic acid dehydrate was used in place of citric acid hydrate in the Example 1.

With respect to respective lithium iron phosphates which were prepared by Examples 1 to 9 and Comparative Examples 1 to 3, identification analysis based on an X-ray diffraction analysis and quantitative analysis of carbon were performed. Primary particle sizes were also measured with respect to the respective lithium iron phosphates. The X-ray diffraction analysis was performed using UltimaIV (X-Ray: Cu—Kα1) made by Rigaku Corporation. The quantitative analysis of carbon was performed using EMIA-620 made by HORIBA, Ltd. by determining a carbon content of lithium iron phosphate. The primary particle size was obtained by an X-ray diffraction analysis using Scherrer equation.

Further, with respect to respective lithium iron phosphates which were prepared by Examples 1 to 9 and Comparative Examples 1 to 3, discharge capacity was measured using a following method. A cathode was prepared in such a manner that a paste having the composition consisting of lithium iron phosphate, acetylene black, polyvinylidene fluoride (KFL #1320 made by KUREHA CORPORATION) at a mass ratio of 86:4:10 was applied to a current collector by coating at 10 mg/cm². An anode was prepared by assembling a half cell (made by Hohsen Corp.) using metallic lithium. An electrolyte having the composition consisting of 1 MLiPF₆/EC (ethylene carbonate) and EMC (ethylmethyl carbonate) at a mass ratio of 3:7 was used. A measuring condition was set such that discharge capacity is obtained by performing a constant current charge up to 4.0 V at 0.2 mA/cm² and, thereafter, by performing a constant current discharge down to 2.5 V at 0.2 mA/cm².

The result of measurement of the above-mentioned identification analysis, carbon content, primary particle size and discharge capacity is shown in Table 1. As can be clearly understood from Table 1, in all Examples 1 to 9, the carbon content is 1.5 mass % or more, and the primary particle size is 100 nm or less, and olivine lithium iron phosphate possessing high discharge capacity was obtained. Particularly, discharge capacity in the Examples 6 to 9 is slightly larger than discharge capacity in the Examples 1 to 5. Hence, it is estimated that such a discharge capacity enhancing effect is brought about by doping. On the other hand, Comparative Examples 1 to 3 did not obtain lithium iron phosphate possessing sufficient discharge capacity. It is estimated that phosphorus, iron and lithium were not mixed uniformly at an atomic level in the Comparative Examples 1 to 3.

TABLE 1

| | | Carbon | Primary | |
|---|---|---|---|---|
| | | content | particle | Discharge |
| | | (mass | size | capacity |
| | Formed phase | %) | (nm) | (mAh/g) |
| Example 1 | LiFePO₄ (olivine) | 1.9 | 76 | 156 |
| Example 2 | LiFePO₄ (olivine) | 2.0 | 70 | 151 |
| Example 3 | LiFePO₄ (olivine) | 1.9 | 88 | 152 |
| Example 4 | LiFePO₄ (olivine) | 1.8 | 82 | 150 |
| Example 5 | LiFePO₄ (olivine) | 2.0 | 74 | 154 |
| Example 6 | LiFe_{0.99}V_{0.01}PO₄ (olivine) | 2.0 | 62 | 158 |
| Example 7 | LiFe_{0.99}Ti_{0.01}PO₄ (olivine) | 2.0 | 64 | 157 |
| Example 8 | LiFe_{0.99}Mg_{0.01}PO₄ (olivine) | 2.0 | 62 | 158 |
| Example 9 | LiFe_{0.99}Mn_{0.01}PO₄ (olivine) | 2.0 | 60 | 157 |
| Comparative | LiFePO₄ (olivine) | 1.9 | 88 | 140 |
| example 1 | | | | |
| Comparative | LiFePO₄ (olivine) | 1.9 | 74 | 142 |
| example 2 | | | | |
| Comparative | LiFePO₄ (olivine), impurity | 1.2 | 90 | 135 |
| example 3 | phase | | | |

### INDUSTRIAL APPLICABILITY

Our methods produce lithium iron phosphate possessing a high discharge capacity as an inexpensive cathode active material by using inexpensive iron particles as an iron source.

1. A method for producing lithium iron phosphate comprising:
preparing an aqueous solution containing a phosphoric acid and a carboxylic acid;
adding iron particles containing 0.5 mass % or more of oxygen to the aqueous solution, and causing the phosphoric acid, the carboxylic acid and the iron particles to react with each other in the aqueous solution under an oxidizing atmosphere, and thereby form a first reaction liquid;
adding a lithium source to the first reaction liquid to form a second reaction liquid;
drying the second reaction liquid to form a lithium iron phosphate precursor; and
baking the lithium iron phosphate precursor under a non-oxidizing atmosphere to obtain lithium iron phosphate.

2. The method according to claim 1, wherein the phosphoric acid is an orthophosphoric acid.

3. The method according to claim 1, wherein the carboxylic acid is at least one selected from the group consisting of tartaric acid, malic acid and citric acid.

4. The method according to claim 1, wherein the carboxylic acid has a content of 0.18 to 0.5 mol for 1 mol of iron in the iron particles.

5. The method according to claim 1, wherein the carboxylic acid has a residual carbon rate of 3 mass % or more.

6. The method according to claim 5, wherein the residual carbon rate of the carboxylic acid is 3 to 20 mass %.

7. The method according to claim 1, wherein the iron particles are at least one selected from the group consisting of reduced iron powder, atomized iron powder and electrolytic iron powder.

8. The method according to claim 1, wherein the iron particles have an oxygen content of 0.6 to 2 mass %.

9. The method according to claim 1, wherein the lithium source is a water soluble lithium salt.

10. The method according to claim 1, wherein preparing the aqueous solution comprises dissolving metal or a compound of an element to be doped in the aqueous solution containing the phosphoric acid and the carboxylic acid.

11. The method according to claim 1, wherein drying the second reaction liquid is performed by a spray dry method.

12. The method according to claim 1, wherein baking comprises baking at a temperature of 300° C. or more.

13. The method according to claim 1, further comprising mixing the lithium iron phosphate obtained the baking and a carbon source, and further baking the mixture under a non-oxidizing atmosphere thus obtaining the lithium iron phosphate whose surface is covered with carbon.

14. The method according to claim 13, wherein the carbon source is a substance which generates carbon through thermal decomposition thereof during the further baking or conductive carbon.

15. The method according to claim 13, wherein the carbon source is added to the lithium iron phosphate such that an amount of carbon contained in the lithium iron phosphate after the further baking becomes 1 to 5 mass %.

16. The method according to claim 1, wherein the lithium iron phosphate is a cathode active material.

17. The method according to claim 16, wherein the cathode active material is in a secondary battery.
